(19) United States
(12) Patent Application Publication
(10) Pub. No.: US 2008/0240306 A1
(43) Pub. Date: Oct. 2, 2008

(54) CORRELATION DEVICE FOR PERFORMING CORRELATION ON A RECEIVED GLOBAL NAVIGATION SATELLITE SYSTEM SIGNAL AND METHOD FOR SAME

(75) Inventors: Kun-Tso Chen, Chang-Hua Hsien (TW); Jui-Ming Wei, Taichung City (TW); Chun-Nan Chen, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/690,878

(22) Filed: Mar. 26, 2007

(51) Int. Cl. H04L 27/06

(52) U.S. Cl. 375/343

(57) ABSTRACT

The invention provides a correlation device performing correlation on a received Global Navigation Satellite System (GNSS) signal. The correlation device comprises a first decimation module, a second decimation module, and a correlation module. The first decimation module decimates a plurality of samples of the received GNSS signal to obtain a plurality of decimated samples. The second decimation module decimates a plurality of code bits of a locally generated replica code to obtain a plurality of decimated code bits. The correlation module correlates the decimated samples with the decimated code bits to obtain a plurality of correlation results, thus achieving a coarse correlation between the received GNSS signal and the locally generated replica code.

### BACKGROUND OF THE INVENTION

1. Field of the Invention

The invention relates to Global Navigation Satellite System (GNSS) receivers, and more particularly to a GNSS signal processing.

2. Description of the Related Art

Global Navigation Satellite System (GNSS) is a collective name for global satellite-based radio navigation systems, including Global Positioning Systems (GPS) for America and Galileo systems for Europe. Before a GNSS satellite broadcasts data requiring transmission, the data is mixed with a Pseudo Random Noise (PRN) code for spreading on a broad spectrum for transmission. A PRN code consists of a long series of bits which continuously repeat themselves. For example, the PRN code of GPS L1 band consists of 1023 bits.

After a GNSS receiver receives a GNSS signal, the GNSS receiver must retrieve transmitted data from the received signal to separate data from the PRN code. This is done by correlating the received signal with a locally generated PRN code, which is a replica of the PRN code of the GNSS transmitting satellite. Because only the equal part of the replica PRN code correlated with the received signal can recover the transmitted data, the replica PRN code must be continuously shifted. Each shift of the replica PRN code corresponds to a code phase of the replica PRN code. When a peak occurs in the correlation result corresponding to a certain code phase, the code phases of the satellite PRN code and the local replica PRN code are synchronous. The GNSS receiver can then lock the code phase of the local replica PRN code to retrieve data from the received signal. The synchronization process is referred to as an “acquisition stage”, and the locking process is referred to as a “tracking stage”.

The aforementioned correlation process requires that the GNSS receiver exerts tremendous computing effort to demodulate the received GNSS signal. Additionally, the required computing effort increases with the bit number contained by the PRN code. New standards for GNSS systems, however, require high chip rates and long PRN codes. For example, the PRN codes of Galileo L1C and E5 bands respectively consist of 8192 and 10230 bits, which are respectively eight and ten times greater than the bit number of the PRN code of the GPS L1 band. FIG. 1A shows the PRN code length of Galileo systems. Longer PRN codes require greater computing effort. If a PRN code becomes N times greater, the signal correlation between one code phase of the local replica PRN code and the received signal requires N times of computation, and the total correlation process requires N² times of computation because the number of code phases is also N times greater.

Partial correlation is an algorithm to simplify a correlation process. FIG. 1B shows a conventional partial correlation process. Samples S_{A}˜S_{N} of a received signal are correlated with samples R_{A}˜R_{N} of a locally generated replica code to obtain a correlation result. The samples S_{A}˜S_{N} of the received signal are pre-divided into groups of S_{A}˜S_{K}, S_{K+1}˜S_{2K}, . . . , and S_{N-K}˜S_{N}, and the samples R_{A}˜R_{N} of the locally generated replica code are divided into groups of R_{A}˜R_{K}, R_{K+1}˜R_{2K}, . . . , and R_{N-K}˜R_{N} in advance. The corresponding samples of the received signal and the locally generated replica code are then multiplied together. For example, samples S_{A} and S_{B} are respectively multiplied by samples R_{A} and R_{B} to obtain products M₁ and M₂. The products are then summed by groups to obtain partial sums. Finally, the partial sums are added together to obtain a correlation result. Because the samples are correlated by groups to obtain the partial sums, the correlation process is partially implemented in each group of samples, and each partial sum requires less computation. The total computation required by the final correlation result, however, is the same as the computation effort required for a full correlation. Thus, a method for reducing correlation computation of GNSS receivers and improving system performance is desirable.

### BRIEF SUMMARY OF THE INVENTION

The invention provides a correlation device performing correlation on a received Global Navigation Satellite System (GNSS) signal. The correlation device comprises a first decimation module, a second decimation module, and a correlation module. The first decimation module decimates a plurality of samples of the received GNSS signal to obtain a plurality of decimated samples. The second decimation module decimates a plurality of code bits of a locally generated replica code to obtain a plurality of decimated code bits. The correlation module correlates the decimated samples with the decimated code bits to obtain a plurality of correlation results, thus, a coarse correlation between the received GNSS signal and the locally generated replica code is achieved.

The invention also provides a method for performing correlation on a received GNSS signal. First, a plurality of samples of the received GNSS signal is decimated to obtain a plurality of decimated samples. A plurality of code bits of a locally generated replica code is decimated to obtain a plurality of decimated code bits. The decimated samples are then correlated with the decimated code bits to obtain a plurality of correlation results.

The invention also provides a method for processing a received GNSS signal. First, a coarse correlation between the received GNSS signal and a locally generated replica code is performed to obtain a coarse correlation result. An approximate range of a code phase of the locally generated replica code is then determined according to the coarse correlation result. A full correlation between the received GNSS signal and the locally generated replica code with the code phase within the approximate range is then performed to obtain a full correlation result. Finally, a precise code phase of the locally generated replica code is then determined for synchronizing the received GNSS signal according to the full correlation result.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A shows a PRN code length of Galileo systems;

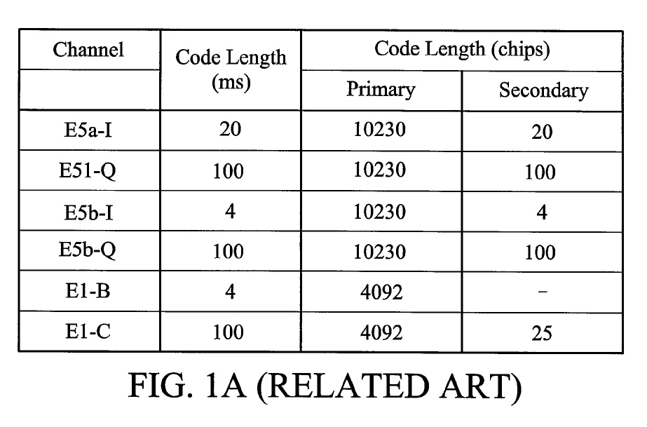

FIG. 1B shows a conventional partial correlation process;

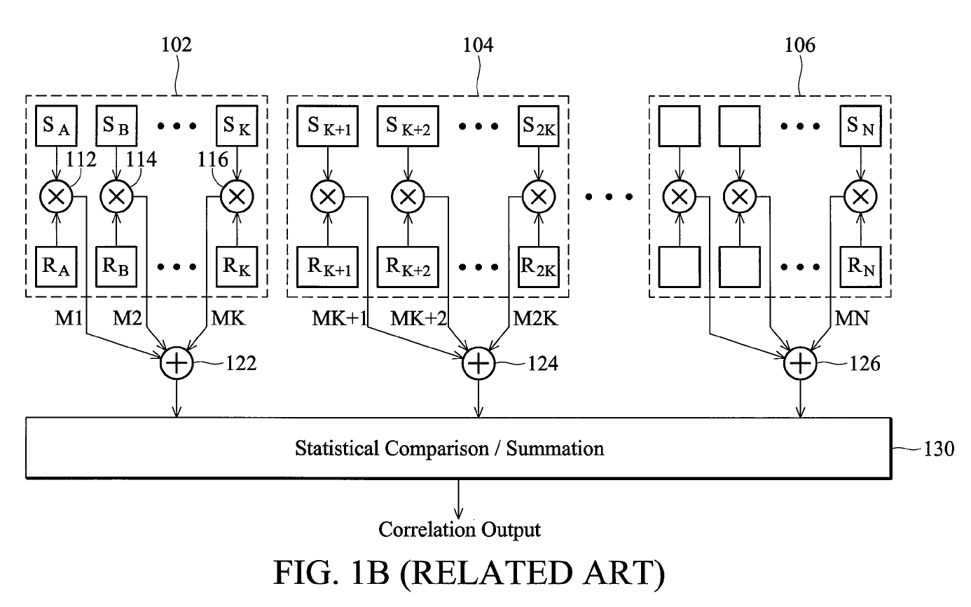

FIG. 2 shows a block diagram of a correlation device performing a coarse correlation on a received GNSS signal according to the invention;

FIG. 3 is a flowchart of a method for processing a received GNSS signal in an acquisition stage according to the invention;

FIG. 4A shows group division of samples and replica code bits;

FIG. 4B shows a block diagram of a correlation device with a decimation process based on the group division of FIG. 4A;

FIG. 5 shows a block diagram of another correlation device with a decimation process based on the group division of FIG. 4A;

FIG. 6A shows another method for decimating samples and code bits according to the invention;

FIG. 6B shows a block diagram of a correlation module corresponding to the decimation method of FIG. 6A according to the invention; and

FIG. 7 shows a block diagram of a correlation device capable of performing both a coarse correlation and a full correlation on a received GNSS signal according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

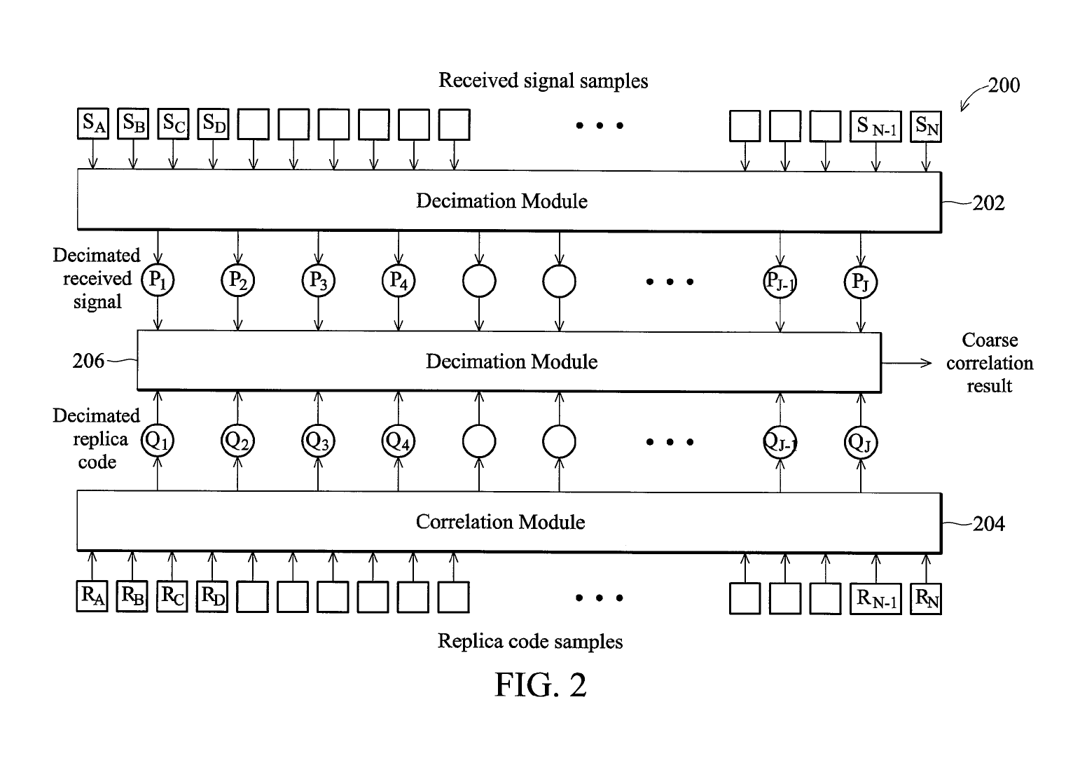

FIG. 2 is a block diagram of a correlation device 200 performing a coarse correlation on a received GNSS signal according to the invention. The correlation device 200 correlates a GNSS signal received by a GNSS receiver with a locally generated replica code. The replica code includes code bits R_{A}˜R_{N}. The received GNSS signal includes samples S_{A}˜S_{N}. A decimation module 202 decimates the samples S_{A}˜S_{N} of the received GNSS signal to obtain decimated samples P₁˜P_{J}, wherein the number J of the decimated samples P₁˜P_{J} is less than the number N of the original samples S_{A}˜S_{N}. Accordingly, a decimation module 204 decimates the code bits R_{A}˜R_{N} of the replica code to obtain decimated code bits Q₁˜Q_{J}, wherein the number J of the decimated code bits Q₁˜Q_{J} is less than the number N of the original code bits R_{A}˜R_{N}. A correlation module 206 then correlates the decimated samples P₁˜P_{J} with the decimated code bits Q₁˜Q_{J} to obtain a correlation result. Because the number J of the decimated code bits Q₁˜Q_{J} and the decimated samples P₁˜P_{J} is less than the number N of the code bits R_{A}˜R_{N} and the samples S_{A}˜S_{N}, the amount of computation required by the coarse correlation between the decimated samples and the decimated code bits is only about (J/N)² times the amount of computation required by a full correlation between the original samples and the original code bits. Thus, the computation required by the coarse correlation of the correlation module 206 is greatly reduced. The received GNSS signal and the replica code can be both time domain signals or frequency domain signals, and the correlation module 206 is correspondingly a time domain correlator or a frequency domain correlator

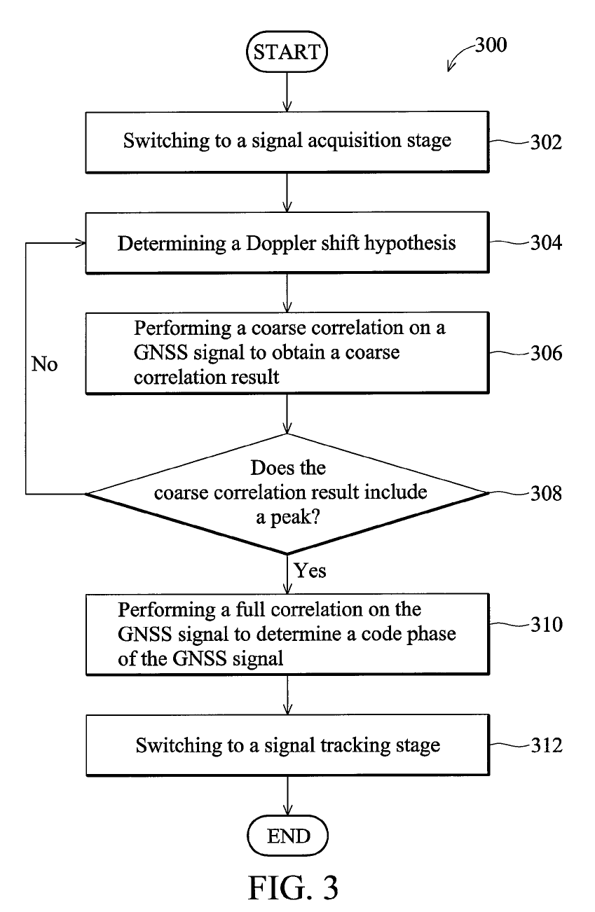

A few samples of the received GNSS signal and a few replica code bits are dropped in the decimation process of the decimation modules 202 and 204. Thus, the coarse correlation of the correlation module 206 generates a correlation result with low precision. In other words, the coarse correlation result with less required computation is obtained at the price of low precision. The negative effects of low precision, however, can be eliminated without losing the benefit of reduced computation. FIG. 3 is a flowchart of a method 300 for processing a received GNSS signal in an acquisition stage according to the invention. First, a signal acquisition stage begins in step 302 to synchronize the code phases of a satellite code and a locally generated replica code. Because a received GNSS signal may have phase shift or distortion due to the Doppler effect, a Doppler shift hypothesis of the received GNSS signal is first determined to eliminate the Doppler effect in step 304. A coarse correlation is then performed on the received GNSS signal with the correlation device 200 of FIG. 2 in step 306 to obtain a coarse correlation result with low precision.

In the coarse correlation of step 306, the received GNSS signal is correlated with different code phases of the locally generated replica code. If a peak occurs in the coarse correlation results corresponding to a certain code phase in step 308, the code phase is taken as a probable code phase synchronized with the satellite code. Thus, an approximate range of probable code phases can be determined according to the coarse correlation results. A full correlation between the received GNSS signal and the locally generated replica code with the probable code phases within the approximate range is then performed in step 310 to obtain a full correlation result with high precision. A precise code phase of the locally generated replica code can then be determined according to the full correlation result for synchronizing the received GNSS signal. Because the code phase is determined, the system is switched to a signal tracking stage in step 312 to lock the received signal. Although the precision of the coarse correlation result in step 306 is low, the precision of the final full correlation result in step 310 is still high, and the time required for the entire acquisition process is reduced due to the reduced computation required for the coarse correlation. Thus, performance of the GNSS receiver is greatly improved.

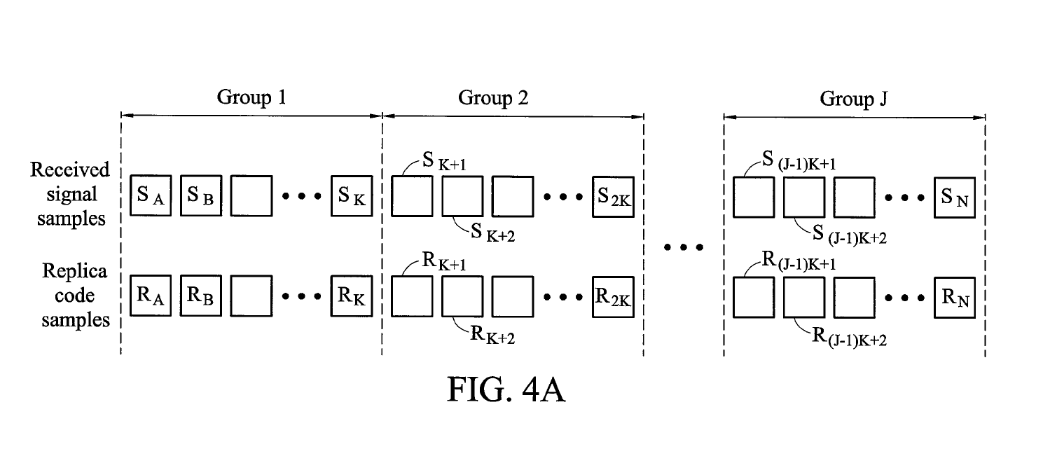

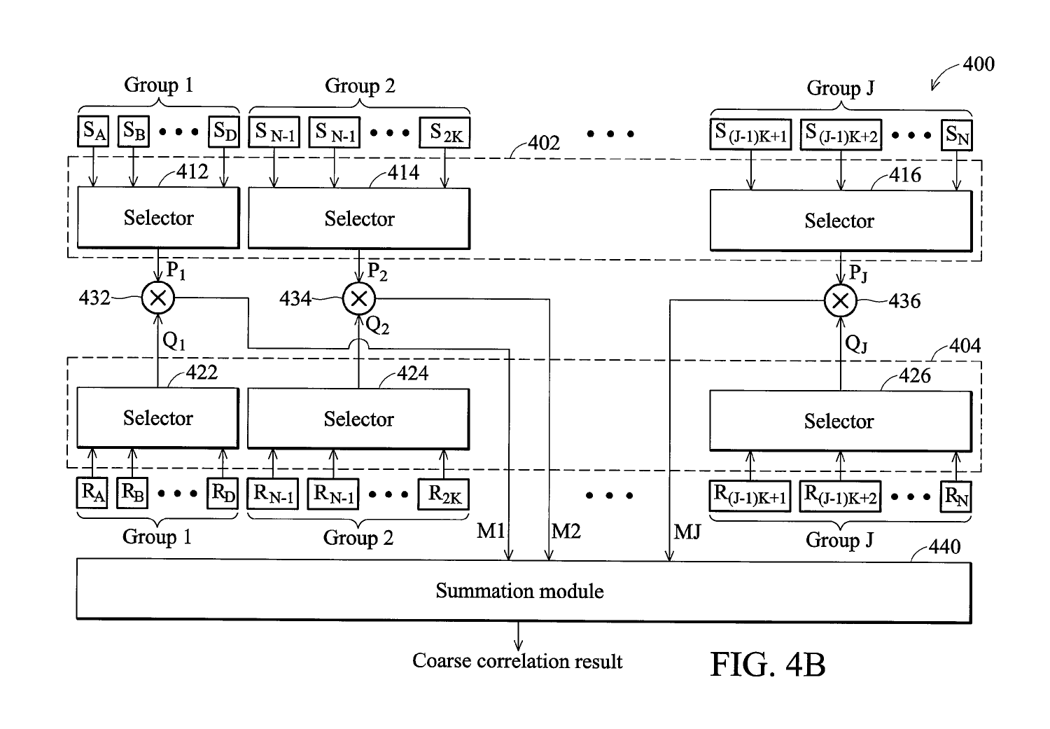

The decimation process generating the decimated samples P₁˜P_{J} and the decimated code bits Q₁˜Q_{J} is illustrated in the following. In one embodiment, the samples and the replica code bits are first divided into a plurality of groups including the same number of samples and replica code bits. The decimation module 202 then generates one decimated sample corresponding to a group of samples, and the decimation module 204 generates one decimated code bit corresponding to a group of code bits, thus, the decimated samples P₁˜P_{J} and the decimated code bits Q₁˜Q_{J} are obtained. FIG. 4A shows group division of the samples and the replica code bits. If only J decimated samples and decimated code bits are generated, the original samples and the original replica code bits are first divided into J groups, each of which includes K samples and K replica code bits. For example, group 1 includes samples S_{A}˜S_{K} of the received signal and replica code bits R_{A}˜R_{K}, and group 2 includes samples S_{K+1}˜S_{2K} of the received signal and replica code bits R_{K+1}˜R_{2K}.

FIG. 4B shows a block diagram of a correlation device 400 with a decimation process based on the group division of FIG. 4A. The correlation device 400 includes a decimation module 402, a decimation module 404, a correlation module comprising multipliers 432˜436 and a summation module 440. The decimation module 402 includes a plurality of selectors 412˜416, each is dedicated to a group of samples and selects one sample from the corresponding group as a decimated sample corresponding to the group. For example, the selector 412 selects a sample from the samples S_{A}˜S_{K} as a decimated sample P₁ corresponding to group 1, and the selector 414 selects a sample from the samples S_{K+1}˜S_{2K} as a decimated sample P₂ corresponding to group 2, thus the decimated samples P₁˜P_{J} with a total number of J is obtained.

Accordingly, the decimation module 404 includes a plurality of selectors 422˜426, each is dedicated to a group of code bits and selects one code bit from the corresponding group as a decimated code bit corresponding to the group. For example, the selector 422 selects a code bit from the code bits R_{A}˜R_{K} as a decimated code bit Q₁ corresponding to group 1, and the selector 424 selects a code bit from the code bits R_{K+1}˜R_{2K} as a decimated code bit Q₂ corresponding to group 2, thus, the decimated code bits Q₁˜Q_{J} with a total number of J is obtained. The multipliers 432˜436 then multiply a decimated sample and a corresponding decimated code bit together to obtain a plurality of product values corresponding to the groups. For example, the decimated samples P₁ are multiplied by the decimated code bit Q₁ with the multiplier 432 to obtain a product value M₁ corresponding to group 1. Finally, all product values M₁˜M_{J} are then summed by the summation module 440 to obtain a coarse correlation result. The multipliers 432˜436 of the coarse correlation module implements only J times of multiplication instead of N times of multiplication in the full correlation, and the summation module 440 of the coarse correlation module implements only J times of addition instead of N times of addition in the full correlation. Thus, the required computation of the coarse correlation is reduced.

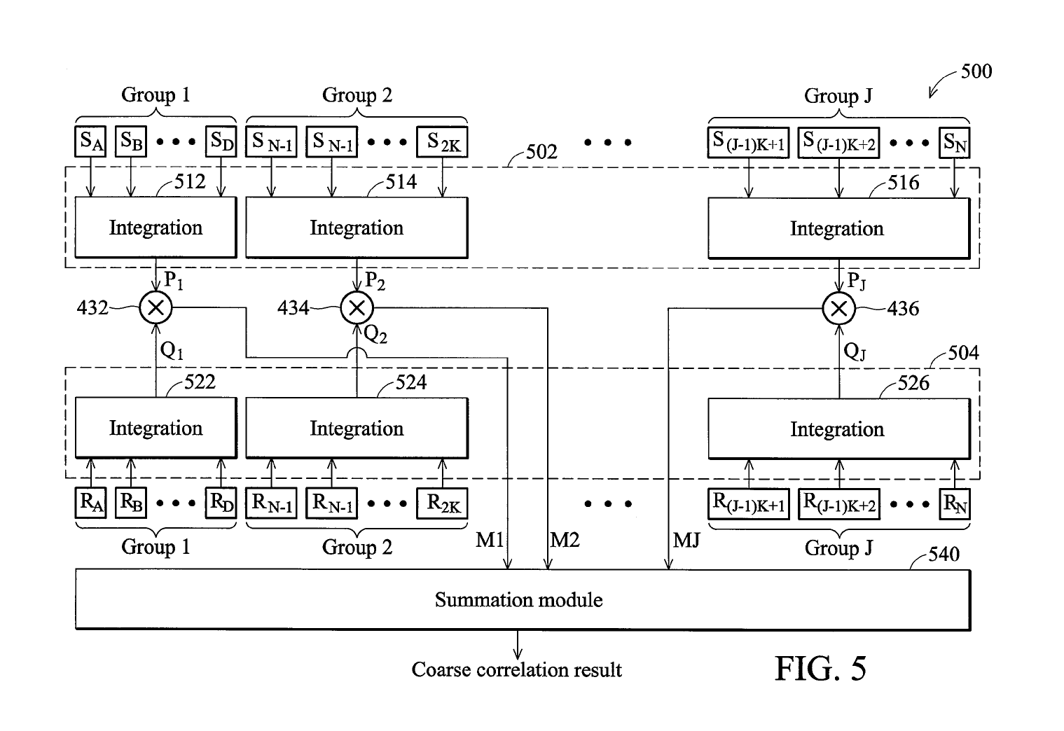

FIG. 5 shows a block diagram of another correlation device 500 with a decimation process based on the group division of FIG. 4A. The correlation device 400 is similar to the correlation device 400, except for the decimation modules 502 and 504. Instead of selectors 412˜416 and 422˜426, the decimation modules 502 and 504 respectively comprise integration modules 512˜516 and 522˜526. Each of the integration modules 512˜516 is dedicated to a group of samples and integrates all samples of the corresponding group together to obtain an integration value of the group. The integration value is then compared with a slicing threshold to obtain a decimated sample corresponding to the group. For example, the integration module 512 selects and integrates the samples S_{A}˜S_{K} to obtain an integration value, which is then compared with the slicing threshold to obtain a decimated sample P₁ corresponding to group 1. Thus, the decimated samples P₁˜P_{J} with a total number of J is obtained. The decimation module 504 generates the decimated samples Q₁˜Q_{J} in the same manner as the decimation module 502.

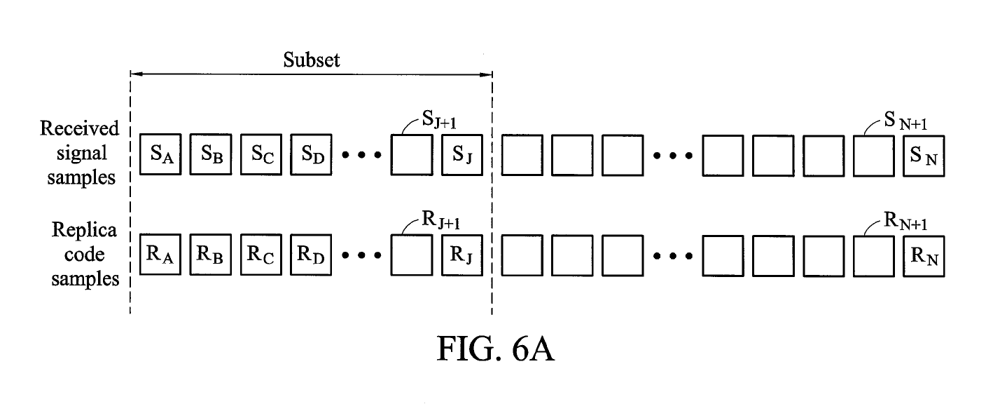

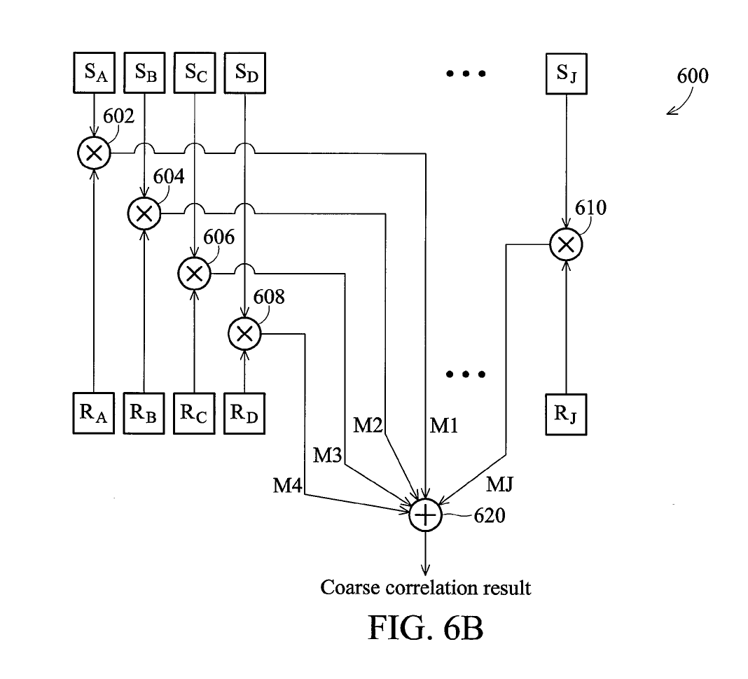

The decimation modules 202 and 204 can still adopt another method for decimating the samples of the received GNSS signal and the replica code bits. FIG. 6A shows another method for decimating the samples and the code bits according to the invention. In one embodiment, the decimation module 202 directly retrieves a segment of samples S_{A}˜S_{J} from the original samples S_{A}˜S_{N} as decimated samples P₁˜P_{J}. Accordingly, the decimation module 204 directly retrieves a segment of code bits R_{A}˜R_{J} from the original samples R_{A}˜R_{N} as decimated samples Q₁˜Q_{J}. The decimated samples SA˜SJ and the decimated code bits RA˜RJ are then delivered to the correlation module 206 to generate the coarse correlation result. FIG. 6B shows a block diagram of a correlation module 600 corresponding to the decimation method of FIG. 6A according to the invention. The correlation module 600 includes a plurality of multipliers 602˜610 and a summation module 620. The multipliers first multiplies each corresponding pair of a decimated sample and a decimated code bit together to obtain a product value. For example, the multiplier 602 multiplies the decimated sample S_{A} and the decimated code bit R_{A} together to generate a product value M₁. All of the product values are then summed up by the summation module 620, and a coarse correlation result is then obtained.

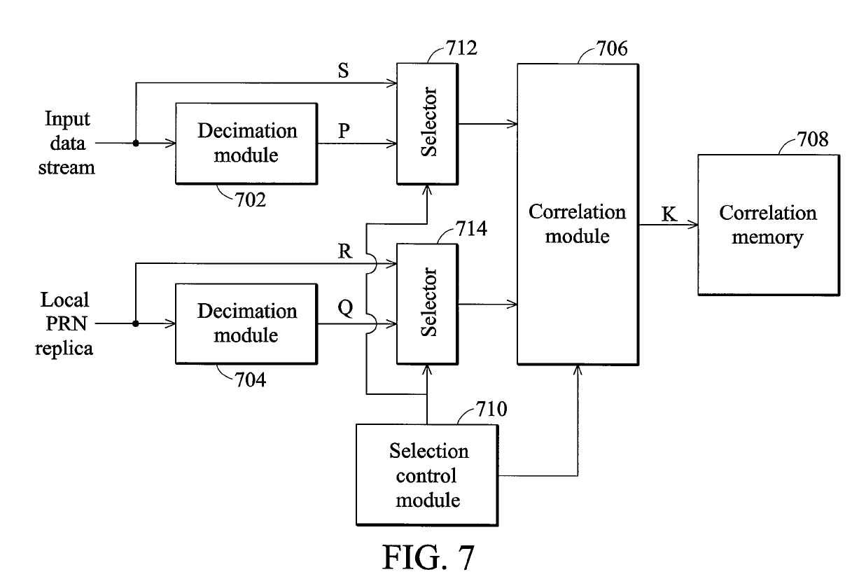

Although the correlation device 200 of FIG. 2 can perform a coarse correlation, the method 300 provided in FIG. 3 requires a correlation device which can perform both a coarse correlation and a full correlation on the received GNSS signal. FIG. 7 shows a block diagram of a correlation device 700 capable of performing both a coarse correlation and a full correlation on a received GNSS signal according to the invention. The correlation device 700 includes decimation modules 702 and 704, a selection control module 710, selectors 712 and 714, a correlation module 706, and a correlation memory 708. The correlation modules 702 and 704 respectively decimate the samples S of the GNSS signal and the replica code bits R to obtain the decimated samples P and the decimated code bits Q. The selection control module 710 then determines whether to perform a coarse correlation or a full correlation between the received GNSS signal S and the locally generated replica code R, and issues a selection control signal to notify the selectors 712 and 714 and the correlation module 706.

If the selection control signal indicates a coarse correlation is performed, the selector 712 blocks the original samples S and passes the decimated samples P to the correlation module 706, and the selector 714 blocks the original code bits R and passes the decimated code bits Q to the correlation module 706. The correlation module 706 then performs a coarse correlation between the decimated samples P and the decimated code bits Q, and stores a coarse correlation result K to the correlation memory 708. If the selection control signal indicates a full correlation is performed, the selector 712 blocks the decimated samples P and passes the original samples S to the correlation module 706, and the selector 714 blocks the decimated code bits Q and passes the original code bits R to the correlation module 706. The correlation module 706 then performs a full correlation between the original samples S and the original code bits R, and stores a full correlation result K to the correlation memory 708. Thus, the correlation device 700 can perform both a coarse correlation and a full correlation for a reduced code phase range according to method 300.

The invention provides a method for performing a correlation on a received GNSS signal. The samples of a received GNSS signal and locally generated replica code bits are first decimated to obtain decimated samples and decimated code bits. The decimated samples and the decimated code bits are then correlated to obtain a coarse correlation result. Thus, the computation required by the coarse correlation result is greatly reduced that required by a full correlation result. The coarse correlation and the full correlation can be switched to acquire both the benefits of computation reduction and correlation precision. Thus, the performance of a GNSS receiver is improved.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A correlation device, performing correlation on a received Global Navigation Satellite System (GNSS) signal, comprising:
a first decimation module, decimating a plurality of samples of the received GNSS signal to obtain a plurality of decimated samples;
a second decimation module, decimating a plurality of code bits of a locally generated replica code to obtain a plurality of decimated code bits; and
a correlation module, coupled to the first decimation module and the second decimation module, correlating the decimated samples with the decimated code bits to obtain a plurality of correlation results, thus achieving a coarse correlation between the received GNSS signal and the locally generated replica code.

2. The correlation device as claimed in claim 1, wherein the received GNSS signal and the locally generated replica code are both time domain signals or frequency domain signals, and the correlation module is correspondingly a time domain correlator or a frequency domain correlator.

3. The correlation device as claimed in claim 1, wherein the samples are divided into a plurality of first groups including the same number of the samples, the first decimation module then respectively generates a decimated sample for each of the first groups to obtain the decimated samples, the code bits are divided into a plurality of second groups including the same number of code bits as the number of samples included by each of the first groups, and the second decimation module then respectively generates a decimated code bit for each of the second groups to obtain the decimated code bits, thus decimating the samples and the code bits.

4. The correlation device as claimed in claim 3, wherein the first decimation module selects a sample from the samples included by each of the first groups as a decimated sample respectively, and the second decimation module respectively selects a code bit from the code bits included by each of the second groups as a decimated code bit, thus obtaining the decimated samples and the decimated code bits.

5. The correlation device as claimed in claim 3, wherein the first decimation module respectively integrates the samples included by each of the first groups to obtain a plurality of first integration values corresponding to the first groups, the first decimation module then compares the first integration values with a first slicing threshold to obtain the decimated samples, the second decimation module respectively integrates the code bits included by each of the second groups to obtain a plurality of second integration values corresponding to the second groups, and the second decimation module then compares the second integration values with a second slicing threshold to obtain the decimated code bits.

6. The correlation device as claimed in claim 1, wherein the first decimation module selects a segment of the samples as the decimated samples, and the second decimation module selects a corresponding segment of the code bits as the decimated code bits, thus decimating the samples and the code bits.

7. The correlation device as claimed in claim 1, wherein the correlation module comprises:
a plurality of multipliers, multiplying the decimated samples by the decimated code bits to obtain a plurality of product values; and
a summation module, connected to the multipliers, summing up the product values to obtain a correlation result.

8. The correlation device as claimed in claim 1, wherein the correlation device further comprises:
a first selector, coupled between the first decimation module and the correlation module, passing the samples or the decimated samples to the correlation module according to a selection control signal;
a second selector, coupled between the second decimation module and the correlation module, passing the code bits or the decimated code bits to the correlation module according to the selection control signal; and
a selection control module, coupling to the first selector, the second selector, and the correlation module, issuing the selection control signal to notify the first selector, the second selector, and the correlation module whether to perform a coarse correlation or a full correlation between the received GNSS signal and the locally generated replica code.

9. The correlation device as claimed in claim 1, wherein the correlation device further comprises a correlation memory, coupled to the correlation module, storing the correlation results generated by the correlation module, wherein the correlation results include coherent correlation results and incoherent correlation results.

10. A method for performing correlation on a received Global Navigation Satellite System (GNSS) signal, comprising:
decimating a plurality of samples of the received GNSS signal to obtain a plurality of decimated samples;
decimating a plurality of code bits of a locally generated replica code to obtain a plurality of decimated code bits; and
correlating the decimated samples with the decimated code bits to obtain a plurality of correlation results.

11. The method as claimed in claim 10, wherein the received GNSS signal and the locally generated replica code are both time domain signals or frequency domain signals, and the correlation results is obtained by correlating the decimated samples with the decimated code bits correspondingly in a time domain or a frequency domain.

12. The method as claimed in claim 10, wherein decimation of the samples comprises:
dividing the samples into a plurality of first groups including the same number of samples; and
respectively generating a decimated sample corresponding to each of the first groups to obtain the decimated samples;
and decimation of the code bits comprises:
dividing the code bits into a plurality of second groups including the same number of the code bits as the number of the samples included by each of the first groups; and
respectively generating a decimated code bit corresponding to each of the second groups to obtain the decimated code bits.

13. The method as claimed in claim 12, wherein generation of the decimated samples comprises respectively selecting a sample from the samples included by each of the first groups as a decimated sample, and generation of the decimated code bits comprises respectively selecting a code bit from the code bits included by each of the second groups as a decimated code bit, thus obtaining the decimated samples and the decimated code bits.

14. The method as claimed in claim 12, wherein generation of the decimated samples comprise
respectively integrating the samples included by each of the first groups to obtain a plurality of first integration values corresponding to the first groups; and
comparing the first integration values with a first slicing threshold to obtain the decimated samples;
and generation of the decimated code bits comprises:
respectively integrating the code bits included by each of the second groups to obtain a plurality of second integration values corresponding to the second groups; and
comparing the second integration values with a second slicing threshold to obtain the decimated code bits.

15. The method as claimed in claim 10, wherein decimation of the samples comprises selecting a segment of the samples as the decimated samples, and decimation of the code bits comprises selecting a corresponding segment of the code bits as the decimated code bits, thus decimating the samples and the code bits.

16. The method as claimed in claim 10, wherein correlation of the decimated samples and the decimated code bits comprises:
multiplying the decimated samples by the decimated code bits to obtain a plurality of product values; and
summing up the products values to obtain a correlation result.

17. The method as claimed in claim 10, wherein the method further comprises:
determining whether to perform a coarse correlation or a full correlation between the received GNSS signal and the locally generated replica code;
correlating the samples with the code bits to obtain the correlation results if the full correlation is determined; and
correlating the decimated samples with the decimated code bits to obtain the correlation results if the coarse correlation is determined.

18. A method for processing a received Global Navigation Satellite System (GNSS) signal, comprising:
performing a coarse correlation between the received GNSS signal and a locally generated replica code to obtain a coarse correlation result;
determining an approximate range of a code phase of the locally generated replica code according to the coarse correlation result;
performing a full correlation between the received GNSS signal and the locally generated replica code with the code phase within the approximate range to obtain a full correlation result; and
determining a precise code phase of the locally generated replica code for synchronizing the received GNSS signal according to the full correlation result.

19. The method as claimed in claim 18, wherein performance of the coarse correlation comprises:
decimating a plurality of samples of the received GNSS signal to obtain a plurality of decimated samples;
decimating a plurality of code bits of the locally generated replica code to obtain a plurality of decimated code bits; and
correlating the decimated samples with the decimated code bits to obtain the coarse correlation result;
and performing the full correlation comprises correlating the samples with the code bits to obtain the full correlation result.

20. The method as claimed in claim 19, wherein decimation of the samples comprises:
dividing the samples into a plurality of first groups including the same number of the samples; and
respectively generating a decimated sample corresponding to each of the first groups to obtain the decimated samples,
and decimation of the code bits comprises:
dividing the code bits into a plurality of second groups including the same number of the code bits as the number of the samples included by each of the first groups; and
respectively generating a decimated code bit corresponding to each of the second groups to obtain the decimated code bits.
